(19) United States
(12) Patent Application Publication
(10) Pub. No.: US 2008/0213036 A1
(43) Pub. Date: Sep. 4, 2008

(54) Ball and Socket Joint

(76) Inventors: Martin Rechtien, Neuenkirchen- Vorden (DE); Helmut Noe, Horstel (DE); Marc Zeidler, Damme (DE)

Correspondence Address: MCGLEW & TUTTLE, PC, P.O. BOX 9227, SCARBOROUGH STATION, SCARBOROUGH, NY, 10510-9227, US

(21) Appl. No.: 11/911,760

(22) PCT Filed: Apr. 20, 2006
(86) PCT No.: PCT/DE06/00702

§ 371 Date: Oct. 17, 2007

(30) Foreign Application Priority Data
Apr. 21, 2005 (DE) 10 2005 018 663.7

(51) Int. Cl. F16C 11/06; B23P 11/00; B23P 15/00

(52) U.S. Cl. 403/140; 29/441.1

(57) ABSTRACT

A ball and socket joint, for example, for an axle system of a motor vehicle. The ball and socket joint has an essentially ring-shaped or pot-shaped joint housing (1), in the essentially cylindrical interior space of which a ball shell 2 can be arranged. The ball 3 of a ball pivot 4 or of a ball sleeve 8 can be accommodated in the ball shell 2 in a slidingly movable manner. The bearing surface 10 of the ball shell 2 is essentially the same as the surface of an ellipsoid of revolution, whose smaller semiaxis coincides with the axial direction of the ball and socket joint. The construction has advantages in terms of service life, fail-safe operation and load-bearing capacity. The more uniform surface pressure distribution in the bearing gap between the ball shell and joint ball guarantees reduced wear and lower moments of friction.

### CROSS REFERENCE TO RELATED APPLICATIONS

This application is a United States National Phase application of International Application PCT/DE2006/000702 and claims the benefit of priority under 35 U.S.C. § 119 of German Patent Application DE 10 2005 018 663.7 filed Apr. 21, 2005, the entire contents of which are incorporated herein by reference.

### FIELD OF THE INVENTION

The present invention pertains to a ball and socket joint, for example, for an axle system of a wheel suspension of a motor vehicle

### BACKGROUND OF THE INVENTION

Ball and socket joints of the type mentioned in the introduction are used, for example, but by no means exclusively, in the area of the wheel suspension, or also as sleeve joints, for example, for articulating roll stabilizers in motor vehicles.

The requirements imposed on such ball and socket joints include especially a high specific load-carrying ability and low bearing clearance under both static and dynamic loads, as well as low maintenance requirement or absence of need for maintenance possibly over the service life of the motor vehicle, the lowest possible weight and small space requirement. In addition, low-cost manufacture shall be possible.

A ball and socket joint usually has an essentially ring-shaped or pot-shaped joint housing, in the interior space of which the bearing shell or ball shell of the ball and socket joint is arranged. The bearing surface of the ball shell, which is in contact with the surface of the ball of the ball and socket joint, essentially corresponding to the shape of the joint ball in ball and socket joints known from the state of the art. In other words, the bearing surface of the ball shell corresponds to the shape of a spherical segment.

Based on manufacturing tolerances of the ball shell as well as due to forces occurring during the mounting of the ball and socket joint, which occur especially when the ball shell is pressed into the joint housing, the shape of the bearing surface of the bearing shell on the completely mounted ball and socket joint does not usually correspond to the intended spherical shape or the shape of the ball of the ball pivot any longer. The shape of the ball shell rather often corresponds approximately to a ellipsoid of revolution, whose greater semiaxis coincides with the longitudinal axis of the ball pivot or the ball sleeve. In other words, this means that the contact between the ball and the ball shell often does not take place over the entire surface, as is actually desirable, but rather only in the middle area of the ball shell in the form of a linear contact or strip-like contact.

In addition, the ball shells of most ball and socket joints have an especially small wall thickness for geometric reasons in the middle area, i.e., in the approximate area in which their diameter is greatest, relative to a longitudinal section through the ball and socket joint. In addition to the shape deviations described, this leads to an especially high spring rate or especially low elasticity of the ball shell in this middle section.

These two factors together cause that the surface pressure between the ball and the ball shell does not usually correspond any longer to the ideal, uniform load distribution on the entire available bearing surface in the ball and socket joints known from the state of the art. The majority of the load is rather concentrated on the mentioned middle section of the ball shell in the area of the greatest diameter thereof relative to the longitudinal section through the ball and socket joint. This leads to non-uniform, increased bearing wear, prematurely increased bearing clearance, lower bearing capacity and reduced service life in the prior-art ball and socket joints.

### SUMMARY OF THE INVENTION

Against this background, the object of the present invention is to provide a ball and socket joint with which the drawbacks of the state of the art are overcome. In particular, the distribution of the surface pressure between the ball and the ball shell shall be as flat and uniform as possible, the specific load-carrying ability and bearing capacity of the ball and socket joint shall be improved, the bearing clearance shall be reduced, and prolonged service life shall be achieved.

The ball and socket joint according to the present invention comprises at first, in the manner known per se, an essentially ring-shaped or pot-shaped joint housing. The joint housing has an essentially cylindrical inner space, in which the ball shell of the ball and socket joint can be arranged. The ball of the ball pivot or of the ball sleeve of the ball and socket joint can be accommodated in the ball shell in a slidingly movable manner.

However, the ball and socket joint is characterized according to the present invention in that the bearing surface of the ball shell essentially corresponds to the surface of an ellipsoid of revolution. The smaller semiaxis of the ellipsoid of revolution coincides with the axial direction of the ball and socket joint, i.e., with the long axis of the ball pivot or with the longitudinal axis of the ball sleeve.

The fact that the bearing surface of the ball shell has the shape of an ellipsoid of revolution causes that the contact between the ball surface and the ball shell is markedly more two-dimensional and is characterized by a more uniform surface pressure distribution in the mounted ball and socket joint, unlike in the state of the art, because the deformation effects and tolerances described in the introduction, which often lead only to a linear or strip-like contact between the ball and the ball shell in the state of the art, are countercompensated because of the fact that the shape of the bearing surface essentially corresponds to an ellipsoid of revolution. In addition, different elasticities of the ball shell, which occur in different areas of the ball shell because of the different wall thicknesses of the ball shell, are counteracted.

The terms “ellipsoid of revolution” and “having the shape of an ellipsoid of revolution” shall not, of course, be interpreted in the strict mathematical sense. A ball shell that has a non-constant radius of curvature in the longitudinal section through the ball and socket joint such that the radius of curvature is slightly smaller in the middle area of the ball shell than in the axial edge areas of the ball shell shall rather also be considered ellipsoidically shaped, an “ellipsoid of revolution” and “having the shape of an ellipsoid of revolution” according to the present invention.

The greater semiaxis of the ball shell having the shape of an ellipsoid of revolution preferably corresponds to the radius of the ball of the ball and socket joint. In other words, this means that the bearing surfaces of the ball shell and the joint ball geometrically intersect or mutually interpenetrate each other in the mathematical sense in the axial edge areas of the ball shell, i.e., in the area of the front sides of the joint housing. Since an actual mutual interpenetration of the bearing surfaces is not possible in the assembled ball and socket joint, this ultimately leads to a certain, defined prestress between the ball shell and the joint ball. Based on the shape of the ball shell according to the present invention, the interpenetration of the bearing surfaces or the defined prestress is concentrated especially on the axial edge areas of the ball shell and progressively decreases with increasing proximity to the middle area of the ball shell.

A clearance-free, full-surface contact will thus become established between the ball shell and the joint ball in the assembled ball and socket joint, and this makes, moreover, possible a uniform distribution of the surface pressure over the entire contact surfaces between the ball shell and the joint ball under load. However, the specific load-carrying ability and bearing capacity of the ball and socket joint also increases as a result, the service life can be prolonged at equal dimensioning, and the ball and socket joint remains in the clearance-free state considerably longer because of the more uniform stress on the bearing surfaces.

The manner in which the ball shell obtains its bearing surface having the shape of an ellipsoid of revolution according to the present invention is irrelevant for the embodiment of the present invention. It is conceivable, for example, that a ball shell manufactured initially with a spherical bearing surface is subjected later to plastic or elastic deformation, for example, even during the operation in which it is pressed into the bearing housing, i.e., order to thus obtain the intended bearing surface having the shape of an ellipsoid of revolution. According to a preferred embodiment of the present invention, the ball shell has, however, the bearing surface having the shape of an ellipsoid of revolution already from the manufacture or the tool. In other words, this means that the desired ellipsoid of revolution shape of the ball shell is produced already at the time of the original shaping of the ball shell. The desired extent of geometric overlap between the joint ball and the ball shell can thus be set especially precisely and reliably.

According to another embodiment of the present invention, the surface of the ball shell is at least slightly concave on the outer circumference of the ball shell. This also leads, similarly to what was described before concerning the joint ball and the joint shell, to a geometric overlap in some areas between the ball shell and the joint housing, in this case between the outer surface of the ball shell and the inner surface of the joint housing. The contact between the ball shell and the joint housing can thus additionally also be improved and the distribution of the surface pressure between the outer surface of the ball shell and the inner surface of the joint housing can likewise be made more uniform and hence with increased bearing capacity.

According to another embodiment of the present invention, the bearing shell has a slot relative to the ball and socket joint in the axial direction. In other words, this means that the ball shell does not represent a closed ring any longer, but is in the form of a “C” (with very small slot width) from the manufacture. This is advantageous because the assembly of the ball and socket joint is simplified hereby. In addition, the slot in the ball shell can be used to absorb thermal expansions in the area of the ball and socket joint, which is of particular significance in the ball and socket joint according to the present invention, because there is an especially intimate and clearance-free contact between the ball shell, on the one hand, and the joint ball and the joint housing, on the other hand, essentially without the possibility of absorbing thermal expansions, in the ball and socket joint according to the present invention due to the ellipsoid of revolution shape of the ball shell.

According to an especially preferred embodiment of the present invention, the ball shell is manufactured from an injection-moldable thermoplastic material, especially polyoxymethylene. Polyoxymethylene has a very low frictional resistance along with high abrasion resistance and high elasticity. In addition, polyoxymethylene has a high chemical resistance, which is significant because of the presence of lubricants and other fuels in motor vehicles.

The manner in which the ball shell is fastened or anchored in the joint housing is at first irrelevant for the embodiment of the present invention. However, according to a preferred embodiment of the present invention, the ball shell is supported in a non-positive manner in the axial direction on both sides in the joint housing. The non-positive axial supporting especially favorably comprises at least 80% of the front surface of the ball shell. The ball shell, which always tends to undergo a certain amount of elastic or plastic creep, is thus supported especially effectively and is enclosed nearly completely all around.

The present invention will be explained in more detail below on the basis of embodiments presented as exemplary embodiments only. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective longitudinal sectional view of a ball and socket joint according to the state of the art;

FIG. 2 is a schematic perspective view of an ellipsoid of revolution;

FIG. 3 is a schematic perspective longitudinal sectional view of an embodiment of a sleeve joint according to the present invention;

FIG. 4 is a schematic perspective view of another ellipsoid of revolution;

FIG. 5 is a schematic enlarged view of a ball shell and the outlines of the joint ball of a sleeve joint according to FIG. 3;

FIG. 6 is a schematic view showing a comparison of the surface pressure distributions between a ball and socket joint according to the state of the art and a ball and socket joint according to the present invention;

FIG. 7 is a schematic isometric view of the ball shell of an embodiment of a ball and socket joint according to the present invention after the original shaping;

FIG. 8 is a schematic isometric view of a ball shell according to FIG. 7 in the installed state in a view corresponding to FIG. 7; and

FIG. 9 is a perspective view of the ball shell of a ball and socket joint according to the state of the art.

### DESCRIPTION OF THE PREFERRED EMBODIMENTS

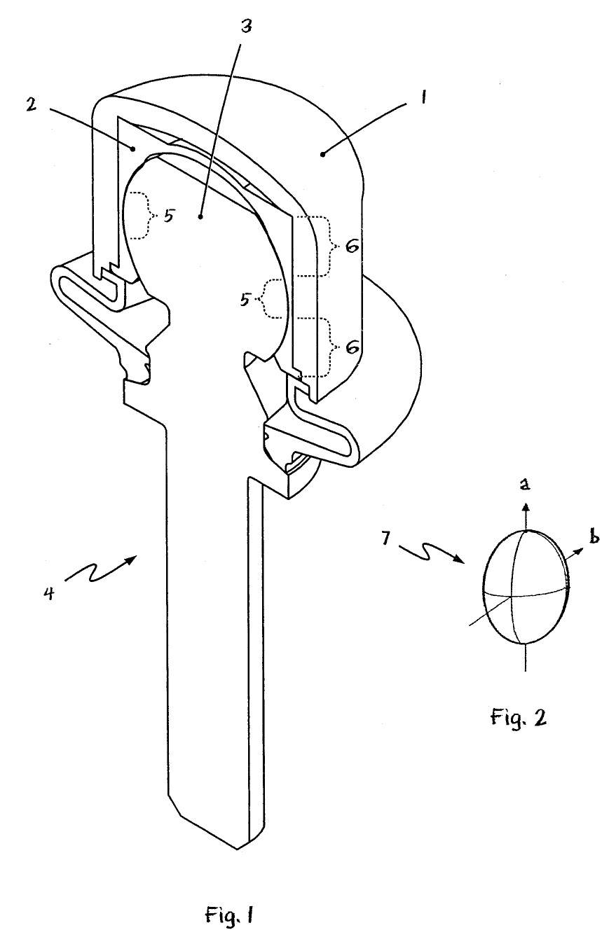

Referring to the drawings in particular, FIG. 1 shows a schematic longitudinal sectional view of a ball and socket joint according to the state of the art. The essentially pot-shaped joint housing 1 with the bearing shell or ball shell 2 arranged therein is recognized. The ball 3 of a ball pivot 4 is in turn arranged in the interior space of the ball shell 2.

It can be clearly recognized that the wall thickness of the ball shell 2 is especially small in the middle area 5 thereof relative to the axial direction of the ball pivot 4, while the wall thickness increases greatly towards the front-side end areas 6 of the ball shell 2 and finally amounts to a multiple of that in the middle area 5 of the ball shell 2 there.

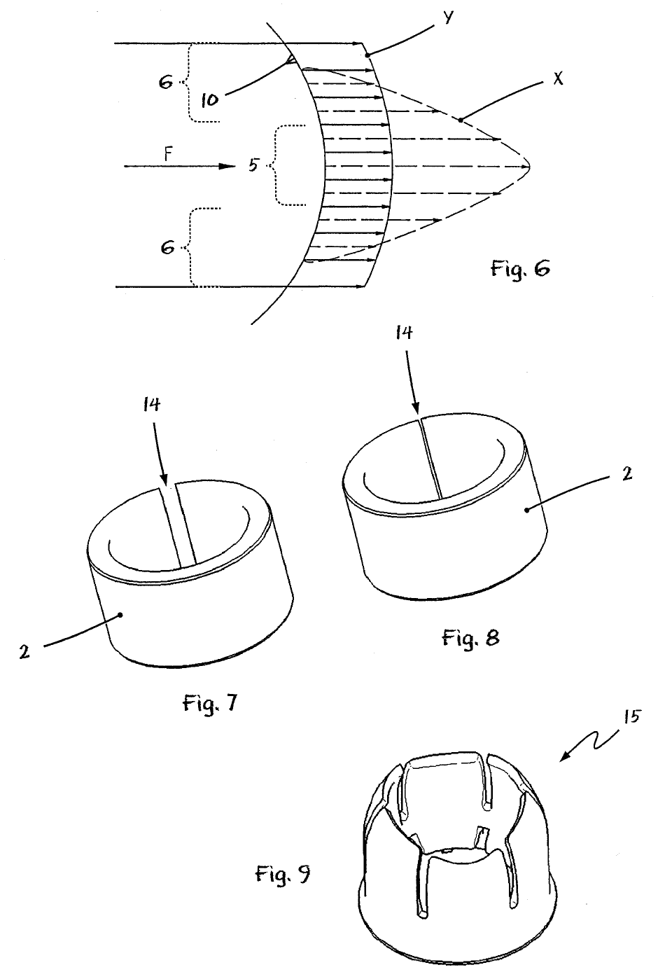

However, as was described in the introduction, this causes that the ball shell 2 has a several times higher spring rate or a much lower elasticity in its middle area 5 than in the areas 6 that are near the end in the axial direction. However, a non-uniform surface pressure distribution inevitably becomes established due to these non-uniform elasticities, as soon as the ball and socket joint is loaded, even in the hypothetical case in which the bearing surface of the ball shell 2 would have the ideal spherical shape. Such a non-uniform surface pressure distribution, plotted over the surface 10 of the bearing 2, is shown as an example in FIG. 6, where the curve designated by X represents the surface pressure distribution of the ball and socket joint from the state of the art according to FIG. 1.

The surface pressure distribution X strongly concentrated on the middle section 5 of the ball shell 2 arises even for the hypothetical case of the ideal spherical shape of the bearing surface from the fact that the near-edge areas 6 of the ball shell 2 yield more strongly without essential absorption of force because of their greater elasticity under load compared to the middle area 5, which is why the middle area 5 of the ball shell 2 must inherently account for the greatest percentage of carrying due to its much lower elasticity.

In addition to this, the ball shell 2 is usually also deformed elastically during mounting in the joint housing 1, so that the bearing surface of the ball shell 2 will have an essentially high ellipsoidal shaped surface after the installation, cf. the schematic view of an ellipsoid of revolution 7 with the principal axes a, b in FIG. 2 for comparison.

The greater principal axis a of the ellipsoid 7 formed by the bearing surface of the ball shell 2 coincides with the longitudinal axis of the ball pivot 3. However, this means that there is no surface contact between the joint ball 3 and the slightly high ellipsoidically deformed ball shell 2 any longer even in the load-neutral state of the ball and socket joint. The surface contact, which is actually desirable, is rather transformed essentially into a linear contact in the middle area 5 of the ball shell 2, i.e., in the area of its smallest wall thickness, because of the deformation of the ball shell 2.

All this leads as a result to a poor contact pattern between the joint ball 3 and the ball shell 2, with the corresponding disadvantageous consequences concerning service life, wear, absence of clearance and load-bearing capacity of the ball and socket joint.

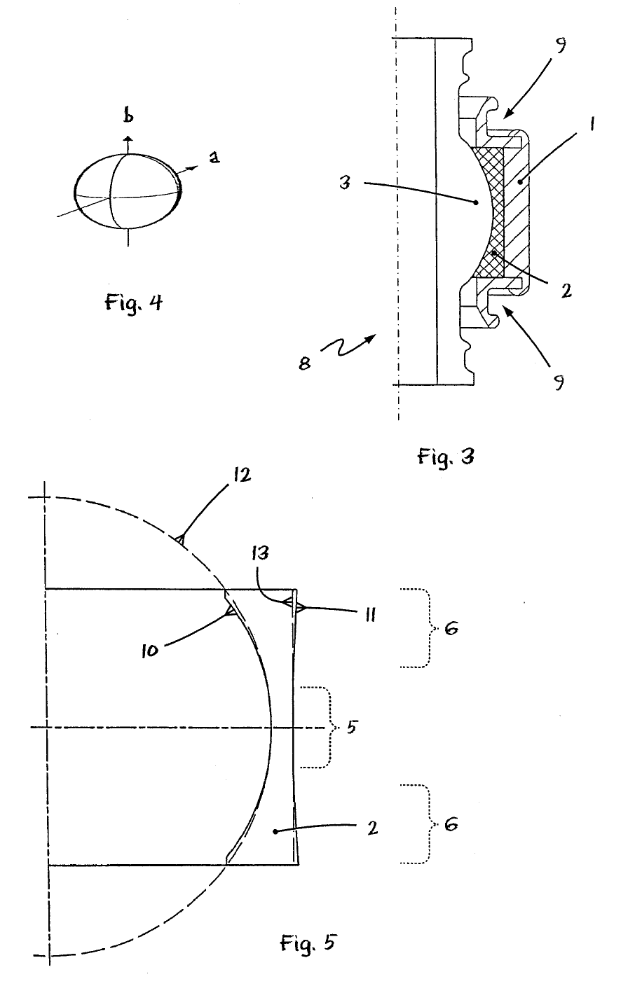

FIG. 3 shows an embodiment of a ball and socket joint according to the present invention, which is designed as a sleeve joint here. A ring-shaped or cylindrical joint housing 1 with a ball shell 2 arranged in the interior of the joint housing 1 is recognized first. The joint ball 3 of a ball sleeve 8 is arranged here in the interior space of the ball shell 2. The ball shell 2 is nearly completely enclosed by the closing rings 9 arranged in the area of the front sides of the joint housing 1 or the ball shell 2, together with the two-dimensional contact with the joint housing 1 and the joint ball 3. Any creep of the material of the ball shell 2 is very extensively avoided in this manner, which is likewise favorable for the service life and the absence of clearance of the ball and socket joint.

The shape of the ball shell areas appears from the schematic view of an example of a transverse ellipsoid according to FIG. 4 or from the enlarged view of the ball shell 2 according to FIG. 5. It is recognized from FIG. 5 that the ball shell 2 has an oversize increasing in the direction of its axial front sides compared to the surface 12 of the joint ball 3 and compared to the cylindrical outer shape 13 both in the area of the inner bearing surface 10 and in the area of its essentially cylindrical outer surface 11 in the embodiment being shown. In other words, this means that the bearing surface 10 of the ball shell 2 according to FIGS. 3 and 5 is no longer spherical (or actually often high ellipsoidal, cf. FIGS. 1 and 2), as in the state of the art, but rather has essentially the shape of a transverse ellipsoid. However, the shorter principal axis b of the ellipsoid of revolution now coincides with the longitudinal axis of the ball and socket joint or the ball sleeve, cf. schematic view of the ellipsoid of revolution according to FIG. 4.

Together with the slightly concave outer contour 111 of the ball shell 2, the ellipsoid of revolution shape of the bearing surface 10 of the ball shell 2 causes the effect of the load concentration in the middle area 5 of the ball shell 2, which was described above, to be counteracted by the areas 6 of the ball shell 2 that are nearer to the edge acquiring a defined extent of radial prestress. Thus, a full-surface contact develops between the ball shell 2 and the joint ball 3 in the assembled state of the ball and socket joint, which leads to the surface pressure distribution between the joint ball 3 and the ball shell 2 becoming more uniform together with the above-mentioned radial prestress.

This is shown as an example in FIG. 4 in the shape of curve Y. Based on the comparison with curve X corresponding to the state of the art, it becomes clearly recognizable that the load F is distributed uniformly over the entire available surface of the ball shell 2. This leads to the above-described higher bearing capacity, improved load-bearing capacity and longer service life of the ball and socket joint, while the bearing clearance is at the same time permanently minimal.

FIGS. 7 and 8 show the ball shell 2 of an embodiment of a ball and socket joint or sleeve joint according to the present invention, wherein the ball shell 2 is shown in FIG. 7 in the state immediately after the original shaping, for example, in the case of a ball shell made of a thermoplastic material according to the injection molding technique. FIG. 8 shows the same ball shell 2 in the installed state. The ball shell according to FIGS. 7 and 8 is divided in the axial longitudinal direction by means of the slot 14, which facilitates the mounting of the ball and socket joint. The joint housing 1, the ball shell 2 and the width of the slot 14 can be dimensioned such that the slot 14 of the ball shell 2 is not fully closed in the mounted state of the ball and socket joint. The small, remaining opening of the slot 14 in the mounted state of the ball and socket joint is available in this case for absorbing thermal expansions of the material of the ball shell 2 in order to thus prevent mechanical warping and stiffness of the ball and socket joint, which is associated herewith.

However, since only a single slot 14 is present here, which is, moreover, extremely narrow in the assembled state, the carrying surface of the ball shell 2 is reduced by the slot 14 to an insignificant extent only, so that the maximum bearing capacity of the ball and socket joint is guaranteed practically without any restriction.

The embodiment of the ball and socket joint according to the present invention which is being considered here with the ball shell according to FIGS. 7 and 8 differs from the state of the art in this respect as well, since ball shells 15 with a plurality of wide slots are usually used in the state of the art, as is shown, for example, in FIG. 9. Even though such ball shells 15 can likewise be mounted in a simple manner, the percentage of the bearing surface of the ball shell 15 is rather substantially reduced, on the one hand, by the numerous wide slots of such ball shells 15. On the other hand, the material of the ball shell 15 may creep during load into the space exposed because of the slots, as a result of which the wall thickness of the ball shell 15 is reduced and whereby a considerable undesired bearing clearance may ultimately develop.

The use of slotted ball shells 2 according to FIGS. 7 and 8 thus likewise makes it possible to increase the reliability, the bearing capacity and the service life of ball and socket joints compared to the state of the art.

It becomes clear as a result that thanks to the present invention, a ball and socket joint is created which offers advantages over ball and socket joints known from the state of the art especially in terms of service life, fail-safe operation and load-bearing capacity. The more uniform surface pressure distribution in the bearing gap between the ball shell and the joint ball guarantees especially low wear and lower moments of friction. Thus, the present invention makes a contribution to the improvement of the reliability of ball and socket joints and the elimination of the need for maintenance of ball and socket joints, especially in respect to use in the area of the axle systems and wheel suspensions of motor vehicles.

While specific embodiments of the invention have been shown and described in detail to illustrate the application of the principles of the invention, it will be understood that the invention may be embodied otherwise without departing from such principles.

1. A ball and socket joint, for an axle system of a motor vehicle, the ball and socket joint comprising:
an essentially ring-shaped or pot-shaped joint housing defining an essentially cylindrical inner space
a ball shell arranged in said essentially cylindrical inner space;
a joint ball of a ball pivot or of a ball sleeve, said joint ball being accommodated in said ball shell in a slidingly movable manner, said ball shell having a bearing surface that is essentially the same as the surface of an ellipsoid of revolution having a smaller semiaxis coinciding with the axial direction of the ball and socket joint.

2. A ball and socket joint in accordance with claim 1, wherein a greater semiaxis of said ball shell is the same as the length of the radius of said joint ball.

3. A ball and socket joint in accordance with claim 1, wherein said ball shell has said ellipsoidically shaped bearing surface is provided in advance at a factory manufacturing the ball shell whereby the ball shell has the ellipsoidically shaped bearing surface prior to the ball shell being arranged in said essentially cylindrical inner space.

4. A ball and socket joint in accordance with claim 1, wherein said surface of said ball shell is concave on the outer circumference of said ball shell.

5. A ball and socket joint in accordance with claim 1, wherein said ball shell has a slot in the axial direction.

6. A ball and socket joint in accordance with claim 1, wherein said ball shell consists of an injection-moldable thermoplastic material.

7. A ball and socket joint in accordance with claim 1, wherein said ball shell is supported in said joint housing in the axial direction on both sides in a non-positive manner.

8. A ball and socket joint in accordance with claim 7, wherein the non-positive axial support comprises at least 80% of each of the front surfaces of said ball shell.

9. A ball and socket joint in accordance with claim 6, wherein said injection-moldable thermoplastic material is polyoxymethylene

10. A ball and socket joint comprising:
a housing having an inner surface defining an inner space;
a ball shell arranged in said inner space said ball shell having an outer surface in contact with said inner surface of said housing and having an ellipsoidically shaped inner bearing surface based on an ellipsoid of revolution with a greater semiaxis and a smaller semiaxis coinciding with the axial direction of the ball and socket joint; and
a ball pivot or a ball sleeve with a joint ball, said joint ball being accommodated in said ball shell in a slidingly movable manner.

11. A ball and socket joint in accordance with claim 10, wherein said greater semiaxis of said ball shell has a length of the radius of said joint ball.

12. A ball and socket joint in accordance with claim 11, wherein said ellipsoidically shaped inner bearing surface is provided in advance at a factory manufacturing the ball shell whereby the ball shell has the ellipsoidically shaped bearing surface prior to the ball shell being arranged in said essentially cylindrical inner space.

13. A ball and socket joint in accordance with claim 12, wherein said outer surface of said ball shell is concave.

14. A ball and socket joint in accordance with claim 12, wherein said ball shell has a slot in an axial direction of the ball and socket joint.

15. A ball and socket joint in accordance with claim 12, wherein said ball shell consists of an injection-moldable thermoplastic material.

16. A ball and socket joint in accordance with claim 10, wherein said ball shell is supported in said joint housing in the axial direction on both sides in a non-positive manner.

17. A ball and socket joint in accordance with claim 16, wherein the non-positive axial support comprises at least 80% of each opposite front surfaces of said ball shell.

18. A process of providing a ball and socket joint, the process comprising the steps of:
providing a housing having an inner surface defining an inner space;
forming a ball shell having an outer surface and an ellipsoidically shaped inner bearing surface based on an ellipsoid of revolution with a greater semiaxis and a smaller semiaxis;
arranged the ball shell in said inner space with the outer surface in contact with the inner surface of said housing and with the smaller semiaxis coinciding with the axial direction of the ball and socket joint;
positioning a joint ball of a ball pivot or a ball sleeve in said ball shell in a slidingly movable manner.

19. A ball and socket joint in accordance with claim 10, wherein said greater semiaxis of said ball shell has a length of the radius of said joint ball and said ellipsoidically shaped inner bearing surface is provided in advance at a factory manufacturing the ball shell whereby the ball shell has the ellipsoidically shaped bearing surface prior to the ball shell being arranged in said essentially cylindrical inner space.

20. A ball and socket joint in accordance with claim 19, wherein
said outer surface of said ball shell is concave;
said ball shell has a slot in an axial direction of the ball and socket joint
said ball shell is formed by injection-molding of thermoplastic material;
said ball shell is supported in said joint housing in the axial direction on both sides in a non-positive manner by at least a portion of opposite front surfaces of said ball shell.
